(19) United States
(12) Patent Application Publication
(10) Pub. No.: US 2013/0248342 A1
(43) Pub. Date: Sep. 26, 2013

(54) FOIL SWITCH FOR ELECTRIC CURRENTS

(71) Applicant: JOHNSON ELECTRIC S.A., Murten (CH)

(72) Inventor: Martin KOEPSELL, Ennepetal (DE)

(73) Assignee: Johnson Electric S.A., Murten (CH)

(21) Appl. No.: 13/849,323

(22) Filed: Mar. 22, 2013

(30) Foreign Application Priority Data
Mar. 23, 2012 (DE) 102012005964.7

(51) Int. Cl. H01H 1/36

(52) U.S. Cl. CPC H01H 1/365
USPC 200/550

(57) ABSTRACT

A switch arrangement for electric currents, has a switch housing; a switching element slidably received in the switch housing; a foil, having electrically conductive pathways for carrying the electric currents, attached to the housing; and at least two contacts that are to be short-circuited and/or opened. At least one of the contacts is formed by a section of the pathway of the foil. The switching element is movable to short-circuit or open the at least two contacts and has a travel path of ≧0.5 mm.

### CROSS REFERENCE TO RELATED APPLICATIONS

This non-provisional patent application claims priority under 35 U.S.C. §119(a) from Patent Application No. 102012005964-7 filed in Germany on Mar. 23, 2012, the entire contents of which are incorporated herein by reference.

### FIELD OF THE INVENTION

This invention relates to an electrical switch and in particular, to a switch arrangement incorporating a foil having at least two contacts to be short-circuited.

### BACKGROUND OF THE INVENTION

Switch arrangements for electric currents, comprising at least two contacts to be short-circuited, are known in many forms and for a wide variety of applications. A switch has at least two contacts, which may be short circuited with one another. This short-circuit creates an electrically conductive flow across the switch. Short circuiting may then occur when the two contacts themselves approach one another or a third contact may also be included as a bridging contact.

Contacts may be formed by wires. Contacts comprising copper pathways on plastic supports are also known on printed circuit boards. Switches may be soldered onto such printed circuit boards. It is possible to ensure reliable operation this way, but the printed circuit board and the soldered switch not only entail more installation effort, more often than not they also result in greater installation height, which is obstructive in some application cases.

Hence there is a desire for a switch arrangement for electric currents, comprising at least two contacts to be short-circuited, which may be produced efficiently and is particularly distinctive for the small number of components involved and the short installed height.

### SUMMARY OF THE INVENTION

This is achieved in the present invention by forming at least one of the contacts by sections of an electrically conductive pathway within a foil, and that a switching element is provided having a travel path of ≧0.5 mm.

Flexible foils with electrically conductive pathways are commonly used as well as rigid printed circuit boards. They can be brought into contact with electrical components, and electric currents are passed across them. Now, according to the invention it is suggested to include such a foil in creating a switch arrangement, that is to say not to secure an external switch with contacts and a housing to a foil, but to integrate the foil together with its electrically conductive pathways in the structure of the switch arrangement.

According to the invention, at least one of the contacts to be short-circuited is formed within the foil by sections of an electrically conductive pathway. The pathway may be exposed in the foil in such manner that it is available for use in an electrical contacting process for conducting electric current. This pathway may be addressed by another, adjacent contact of the switch arrangement, so that an electrically conductive flow is opened or closed.

Also according to the invention, a switching element having a travel path of ≧0.5 mm is provided. This switching element is able to travel a relatively long distance, so that it is able to compensate for tolerances that occur. The fact that a foil is used to create the contact also helps to reduce noise. The approach and separation movements of sections of foil towards one another and/or away from additional components on these foils may be performed noiselessly, for example by sliding over the smooth foil.

According to a first refinement of the invention, both contacts to be short-circuited may also be formed by sections of electrically conductive pathways within the foil. The contacts may for example be located at a distance from one another, at which time an electrical circuit is open, if the contacts are moved towards one another for example by applying pressure to the foil, the contact is closed and it is possible for electricity to flow.

Even when both contacts are arranged within a foil, a bridging contact may be provided additionally to short-circuit the contacts, and the bridging contact may also be arranged inside the foil. Again, a pressure from outside for example may be exerted on the bridging contact so that it moves towards the two electrical contacts, finally coming into contact with them and thus creates a bridge.

One of the first benefits of arranging the conductive contacts as well as a bridging contact inside a foil is that it enables very low installed height. In addition, the creation of contacts of this kind is automatable and thus simplified because the establishment of the contact may be integrated in the foil production. The foil also features a closed construction, so that the switch arrangement according to the invention is isolated from external factors such as moisture or dust.

According to a further refinement of the invention, it is provided that a contact to be short-circuited is resiliently charged via a spring element arranged inside the foil. This configuration has a further alternative, according to which a spring element may be provided for resiliently charging a contact to be short-circuited, for example a spring element with a clicker mechanism or similar component that evokes a certain switching feel.

When configuring contacts to be short-circuited and a bridging contact arranged inside the foil, it is preferably provided that an initial insulating gap is formed between these contacts and that a switching element is present to remove this gap. Besides the foil with the various contacts, a switching element is also present for forming the switch arrangement, and this switching element serves to move the bridging contact towards the contacts to be short-circuited. The switching element thus enables the switch arrangement to be opened and closed.

In this context, it may also be provided that the contacts to be short-circuited and the bridging contact are arranged one on top of the other. For this purpose, the foil may particularly have superposed foil layers, the contacts to be short-circuited and the bridging contact are assigned to the various foil layers. If a pressure is then applied to the bridging contact from above, the bridging contact moves towards the layer with contacts to be short-circuited and short circuits them. In the normal state, a gap is present between the contacts, for this purpose at least one separating layer creating an intermediate space may be arranged between the foil layers with the contacts.

In order to create the switching element, a further refinement of the invention provides that the switching element is a slider accommodated in a sliding guide and furnished with a prominence that acts on the bridging contact. When the slider is displaced, the prominence acts on the bridging contact and this action causes the bridging contact to approach the contacts to be short-circuited until finally a short circuit is created. By exerting the pressing action indirectly via a slider, it is possible to provide greater tolerances for the area surrounding the switch arrangement. The sliding movement may be designed to be long enough to ensure that the bridging contact approaches the contacts to be short-circuited. The sliding guidance for opening and closing also takes place in one dimension, movement in a direction diagonally to this one-dimensional movement is not provided. This results in reduced wear, so that the switch has a longer service life and delivers a constant electrical signal for the duration of its service life.

The sliding guide may have the form of a housing into which portions of the foil protrude. This housing is constructed for example from two housing halves that have been pressed towards the foil and each other from opposite sides of the foil, and have been combined to form a housing. The contacts are guided into the interior of the housing together with the foil, and there they may be influenced by a slider that is accommodated inside the housing.

In order to create the switch arrangement, it may be provided that the slide in the sliding guide is placed under tension by at least one compression spring and has at least one tappet protruding from the sliding guide. The tappet may absorb a pressing motion on the switch, for example in the interior of a motor vehicle by moving towards a car door or similar. When this pressure is exerted on the tappet, the tappet is displaced in the sliding guide against the force of the compression spring, which causes the prominence to press the bridging contact against the contacts to be short circuited. If the pressure on the tappet is reduced, the compression spring allows the slide and tappet to return to its original position, and the switch arrangement is opened.

It may further be provided that at least one contact to be short circuited is formed by a contact body fixed in the foil in an electrically conductive manner. A contact body may be of more solid construction than a conductive pathway in the foil. With such contact bodies, it is also possible to pass currents with greater current strengths across the switch arrangement, to advantageous effect.

Finally, for the purposes of further variation, it may also be provided that the foil layers are constructed from a single foil, at least portions of which are folded or bent. The various layers with the contacts may thus be formed by a single foil, which has first been folded and separate sections of which have then been superposed on each other.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a perspective view of a switch arrangement for electrical currents according to the invention;

FIG. 2 is another perspective view of the switch arrangement of FIG. 1 that has been rotated through 180° and with a housing wall removed;

FIG. 3 is an enlarged, schematic cross-sectional view of a component of the switch arrangement of FIG. 1;

FIG. 4 is a similar view of an alternative embodiment of the component shown in FIG. 3 of the switch arrangement according to FIG. 1; and

FIG. 5 is a similar view of another alternative embodiment of the component shown in FIG. 3 of a switch arrangement according to FIG. 1.

### DETAILED DESCRIPTION OF THE PREFERRED EMBODIMENTS

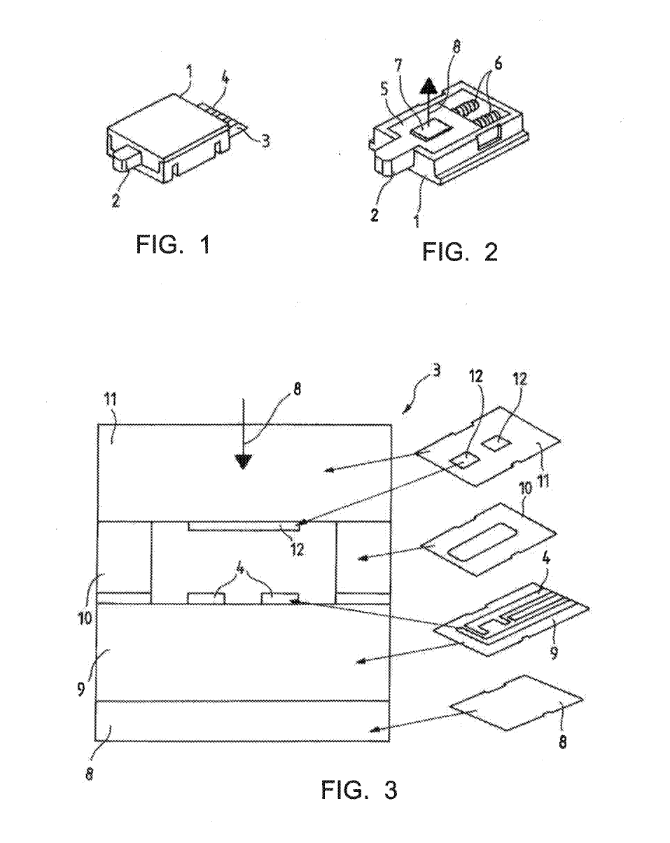

The switch arrangement of FIG. 1 comprises a housing 1 constructed with two housing walls and an operating finger or tappet 2 protruding from housing 1. Housing 1 is of flat construction. A foil 3 protrudes into the interior of housing 1; foil 3 has electrically conductive pathways 4.

FIG. 2 shows the switch arrangement without one of the housing walls indicated in FIG. 1 and without foil 3. Tappet 2 is a part of slider 5, which is retained in a sliding guide formed by housing 1. Slider 5 is pretensioned with two compression springs 6. A projection or prominence 7 is arranged on the top of the slider shown in FIG. 2, and this may be used to exert a pressure in the direction of arrow 8. Prominence 7 thus forms a pressure application means.

FIG. 1 shows that foil 3 is attached directly to the switch housing. Slider 5 with prominence 7 is arranged to slide along the surface of foil 3 with prominence 7 applying localized pressure to cause localized resilient deformation of foil 3. The structure of foil 3 is shown in FIG. 3 in the form of a first embodiment. From the bottom upwards, the construction of foil 3 includes an adhesive layer 8, followed by a foil layer 9 that incorporates electrically conductive pathways 4. Electrically conductive pathways 4 may be made, for example, from silver or may have a silver coating. An alternative material may be copper with a precious metal coating. A separation layer 10 is arranged on top of foil layer 9, and this ensures a separation between first foil layer 9 and a second foil layer 11. The second foil layer 11 includes bridging contact 12, which is pressed against the contacts formed by electrically conductive pathways 4 by the application of pressure in the direction of arrow 8 in FIG. 3. This causes the switch arrangement to close.

Slider 5 with tappet 2 is able to travel a long distance in order to ensure that the contact is closed. FIG. 3 shows that contact pathways 4 in foil layer 9 are formed closer to one another in two areas, while second foil layer 11 is also furnished with two bridging contacts 12. Thus, two contacts may be opened or closed one after the other by slider 5. Alternative configurations of the contact construction are possible.

In use, force acting on the tappet 2 causes the slider 5 to slide within the housing. As the slider moves the location of the prominence 7 also moves along the foil. The prominence 7 applies a force 8 on the foil 3 to locally compress the separation layers 10 and/or to deform the foil so that the bridging contacts 12 are, in turn, pressed against the contacts formed by the conductive pathways 4, thus operating the switch.

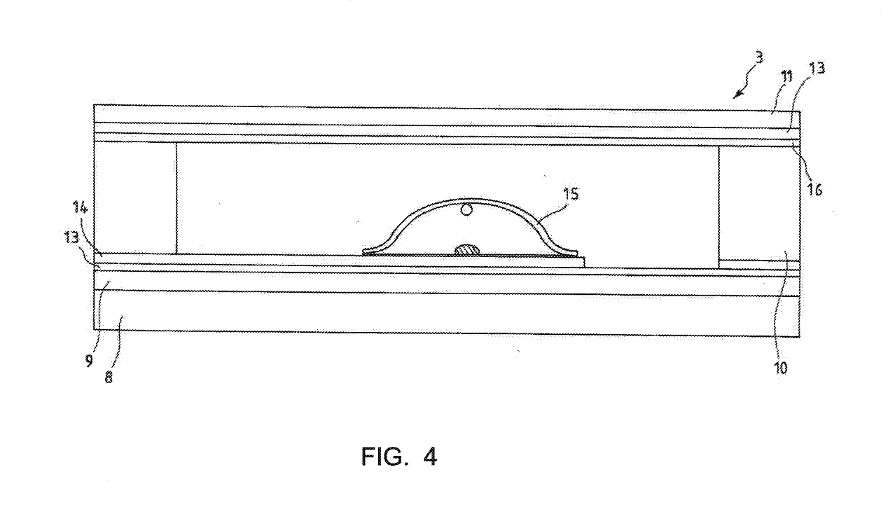

FIG. 4 shows an alternative construction in the interior of foil 3. On a first foil layer 9 there is an adhesive layer 13, and a layer of copper 14 is on top of this. A spring element 15 is arranged on this copper layer 14, and this spring element may have the form of a clicking mechanism, for example.

In this case too, a separation layer 10 is present, and a second layer of copper 16, adhesive layer 13 and another foil layer 11 are added on top of this.

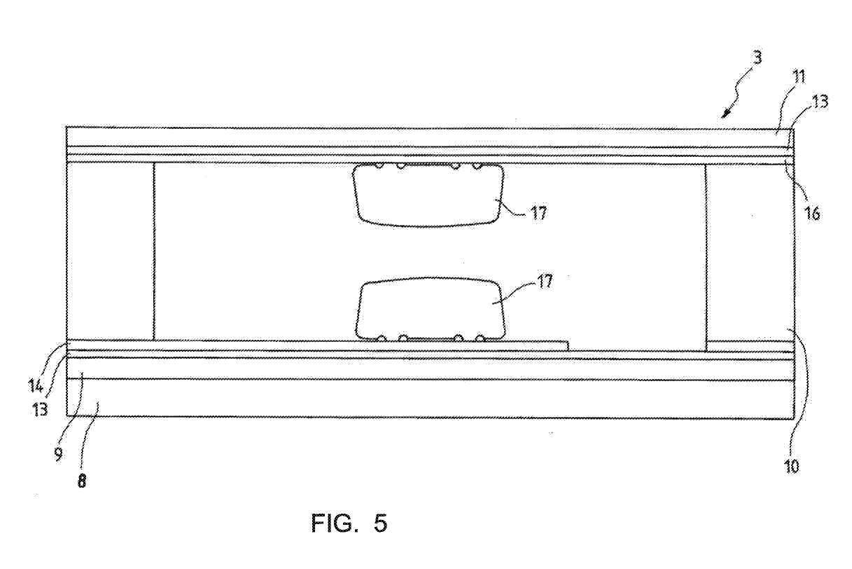

In FIG. 5, copper layers 14, 16 are equipped with contact bodies 17. These are disposed in an electrically conductive manner on copper layers 14, 16 so that they are able to conduct high current strengths.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A switch arrangement for electric currents, comprising: a switch housing; a switching element slidably received in the switch housing; a foil, having electrically conductive pathways for carrying the electric currents, attached to the housing; and at least two contacts that are to be short-circuited and/or opened, wherein at least one of the contacts is formed by a section of the pathway of the foil, and the switching element is movable to short-circuit or open the at least two contacts and has a travel path of ≧0.5 mm.

2. The switch arrangement of claim 1, wherein both contacts are formed by the electrically conductive pathways of the foil.

3. The switch arrangement of claim 1, wherein a bridging contact is also provided to short circuit the contacts, and this too is arranged inside the foil.

4. The switch arrangement of claim 1, wherein a contact to be short circuited is resiliently charged by a spring element, which is arranged inside the foil.

5. The switch arrangement of claim 3, wherein an isolating gap is formed between the contacts to be short circuited and the bridging contact, and that the switching element is provided to remove this isolating gap.

6. The switch arrangement of claim 5, wherein the contacts to be short circuited and the bridging contact are arranged one above of the other.

7. The switch arrangement of claim 6, wherein the contacts to be short circuited and the bridging contact are arranged between foil layers lying one on top of the other.

8. The switch arrangement of claim 7, wherein at least one separating layer creating an intermediate space is arranged between the foil layers with the contacts.

9. The switch arrangement of claim 5, wherein the switching element is a slider that is retained in a sliding guide and is equipped with a prominence that act on the bridging contact.

10. The switch arrangement of claim 9, wherein the sliding guide is formed by the housing into which portions of the foil protrude.

11. The switch arrangement of claim 9, wherein the slider in the sliding guide is placed under tension by at least one compression spring and has at least one tappet protruding out of the sliding guide.

12. The switch arrangement of claim 1, wherein at least one contact to be short circuited is formed by an electrically conductive contact body that is fixed with the foil.

13. The switch arrangement of claim 5, wherein the foil layers are formed from a single foil, which is present in a folded and/or bent condition.

14. The switch arrangement of claim 10, wherein the foil has a closed compartment sealing the contacts and the conductive pathways from external contamination.
